(19) United States
(12) Patent Application Publication
(10) Pub. No.: US 2010/0280795 A1
(43) Pub. Date: Nov. 4, 2010

(54) SENSING METHOD FOR IMPROVED SENSING MODULE

(75) Inventors: Jang-Ping Sheu, Hsinchu (TW); Chia-Chi Chang, Hinchu (TW)

Correspondence Address: ROGER H. CHU, 19499 ERIC DRIVE, SARATOGA, CA, 95070, US

(73) Assignee: NATIONAL TSING HUA UNIVERSITY (TAIWAN), Hsinchu (TW)

(21) Appl. No.: 12/606,189

(22) Filed: Oct. 27, 2009

(30) Foreign Application Priority Data
Apr. 29, 2009 (TW) 098114279

(51) Int. Cl. G06F 17/40

(52) U.S. Cl. 702/187

(57) ABSTRACT

A sensing method for an improved sensing module comprises the steps of: (1) determining whether a sensed object is the same to previous one; (2) collecting sensed signals by using a sensor; (3) processing the sensed signals to produce sensed data through a central processor; (4) determining whether a moment to transmit the sensed data is approached; (5) capturing and transmitting the sensed data; (6) receiving the sensed data by a computer of an end user; (7) writing the sensed data into a flash memory; (8) determining whether the flash memory is full, if so, going to step (5), otherwise, going to step (2); and (9) updating the data in an API by the end user for executing step (2).

### CROSS-REFERENCE TO RELATED APPLICATION

This application claims foreign priority from a Taiwan Patent Application, Ser. No. 098114279, filed on Apr. 29, 2009.

### BACKGROUND OF THE INVENTION

1. Technical Field

The present invention is related to a sensing method for an improved sensing module, more particularly, a hardware platform that is composed of module components with an API to achieve the wireless sensing objective.

2. Description of Related Art

In recent years, the advancement of sensing technology has driven the applications in the fields of military equipment, optoelectronic development, biological researches, chemical engineering, medical appliances, and environment engineering, etc., therefore, various hi-tech sensing technologies have been worldwide developed and applied, in addition, various sensor applications have been made in daily lives of general public, such as carbon monoxide sensor in a vehicle, smoke detector, sprinkler system, and temperature sensor in a building, etc.

A conventional sensor has to be placed in a detection location for collecting sensed data of a certain sensed object, and then, the sensor is brought to the lab for subsequently analyzing the sensed data. Nevertheless, some locations for collecting the sensed data are not easily approachable, for example, a high mountain, a forest, a disaster area, a chemical pollution area, or a battlefield, etc., that is dangerous for people to take risks to place and take back those sensors; Besides, that is also time consuming for people to constantly place and take those sensors back and forth in order to collect data. Therefore, to enable the sensor to connect a wireless transmission device to send collected the sensed data to computer end is a must for further data analysis. Although prior arts have such a design, there are still some functional disadvantages in practical applications as follows:
1. The sensor only contains a sensor to sense the particular sensed object.
2. The wireless module continuously sends data to consume battery energy, so that the battery has to be constantly replaced, therefore, it requires time spending and manpower to retrieve the sensor from the location back and forth.
3. Large sized sensor occupies space and increase more manufacturing costs.
4. The MCU has no the relevant API for the sensor; although various sensor components can be replaced to detect different sense subjects, the sensor components can not be rectified, consequently, the prior arts are unable to ensure the wireless sensing accuracy.

### BRIEF SUMMARY OF THE INVENTION

In view of the aforementioned disadvantages and problems of the prior art, the primary objective of the present invention is to provide a sensing method for an improved sensing module, not only utilizing the data in an API to rectify and control various sensing components, but also comprising the sensing method and flow to achieve the wireless objectives of sensing, processing, and transmitting sensed data.

Another objective of the present invention is to provide the improved sensing module, which is a hardware platform composed of integrated components with the API to achieve the objective of automatic wireless sensing.

In view of the aforementioned objectives, a sensing method for an improved sensing module of the invention comprises the following steps : (1) determining whether a sensed object is the same to previous one; if so, going to step (2), otherwise, going to step (9); (2) collecting sensed signals by using a sensor; (3) processing the sensed signals to produce sensed data through a central processor; (4) determining whether a moment to transmit the sensed data; if so, going to step (5), otherwise, going to step (7); (5) capturing and transmitting the sensed data; (6) receiving the sensed data by a computer of an end user; (7) writing the sensed data into a flash memory; (8) determining whether the flash memory is full, if so, going to step (5), if otherwise, going to step (2); and (9) updating the data in an API by the end user for executing step (2).

### BRIEF DESCRIPTION OF THE SEVERAL VIEWS OF THE DRAWINGS

The objects, spirits, and advantages of the preferred embodiments of the present invention will be best understood by the accompanying drawings and detailed descriptions, wherein:

FIG. 1 is a configuration diagram of modules disposed at an improved sensing module according to the invention; and

FIG. 2A, FIG. 2B, and FIG. 2C are flow charts showing the steps of a sensing method for the improved sensing module according to the present invention.

### DETAILED DESCRIPTION OF THE INVENTION

To explain a sensing method of an improved sensing module of the present invention more clearly, detailed description will be made hereinbelow with reference to the attached drawings.

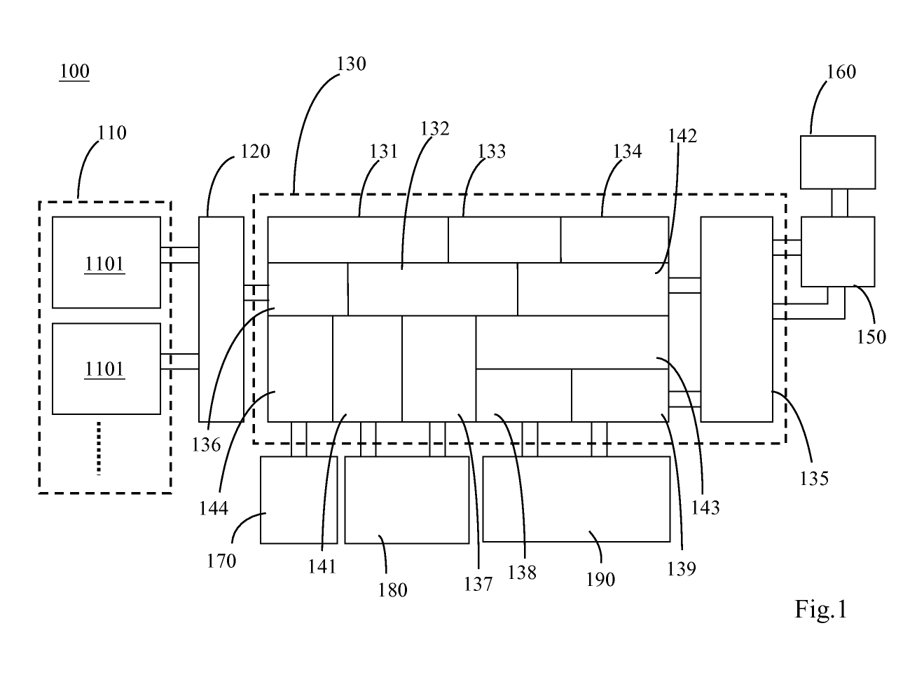

Referring to FIG. 1, an improved sensing module 100 comprises: a sensor 110, an amplifier 120, an MCU 130, a power amplifier 150, an antenna 160, a battery 170, a connector 180, and a USB connector 190. The sensor 110 comprises at least one and above sensing components 1101 to collect sensed analog signals of a sensed object; the amplifier 120 amplifies the sensed analog signals to enables the sensed analog signals to be identified more clearly for subsequently analyzing data.

the MCU 130 comprises: an Analog-to-Digital Converter (ADC) 136 to transform the sensed analog signals amplified by the amplifier 120 into sensed digital signals; a central processor 132 to process the sensed digital signals to sensed data; a Static RAM (SRAM) 131, which is a temporary data storage area for storing the sensed data after being processed by the central processor 132; a flash memory 133 as a storage area for storing the sensed data; an EEPROM 134 as a storage area for storing the data in an API (application programming interface) required by the improved sensing module 100; a Radio IC 135 to transform the sensed data into a wireless protocol format and to transmit the sensed data; an I2C BUS 137 as the connections for the central processor 132 to the outside of the central processor 132, including the Static RAM (SRAM) 131, the Radio IC 135, and an external IC; an I/O interface 141 as the input and output interface for the MCU 130; a universal asynchronous receiver transmitter (UART) 138, which is a transmission device for transmitting serial data among the MCU 130 and peripheral devices; a serial peripheral interface (SPI) 139, which is a transmission device for transmitting serial data among the MCU 130 and peripheral devices; a DC/DC Converter 144 for increasing or reducing the electric power voltage of the battery 170 to the required voltage for the improved sensing module 100; an in-system programming device 143 to update the data in the API through the serial peripheral interface (SPI) 139; and a self programming device 142 to write the sensed data into the flash memory 133.

Moreover, the power amplifier 150 increases the power and the distance of a wireless transmission; the antenna 160 be a media for sending and receiving data through the wireless transmission; the battery 170 is a polymer lithium battery with the characteristics of high energy density and discharge efficiency to keep long-time operation of the improved sensing module 100; the connector 180 is able to connect the external IC, in addition, connect the central processor 132 through the I/O interface 141; the USB connector 190 is able to directly connect a USB interface of a computer, hence, a end user is able to directly access the sensed data that is stored in the flash memory 133, moreover, request the data in the API to be stored in the EEPROM 134.

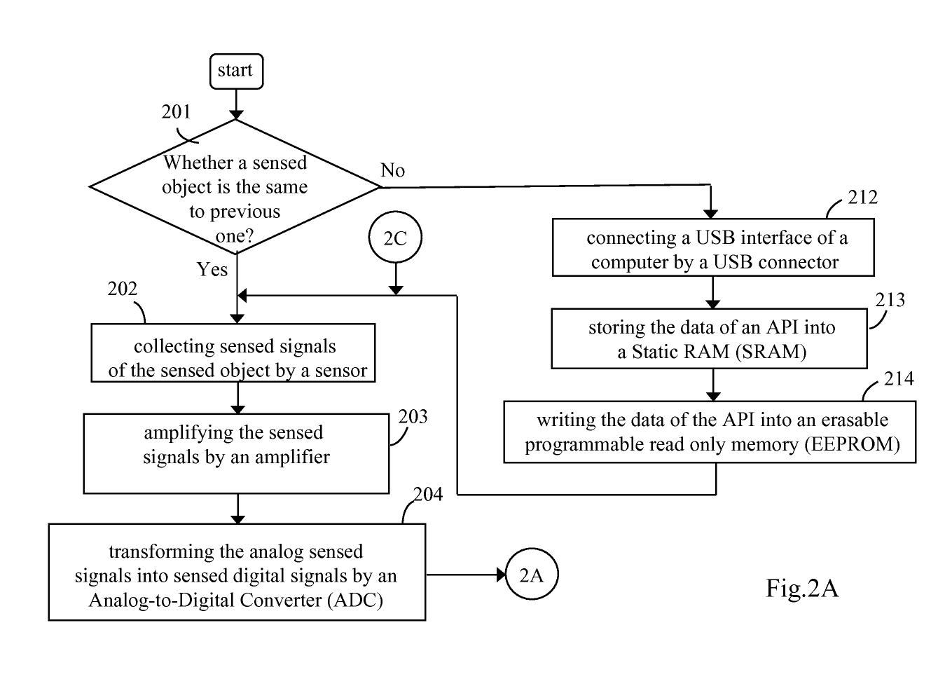

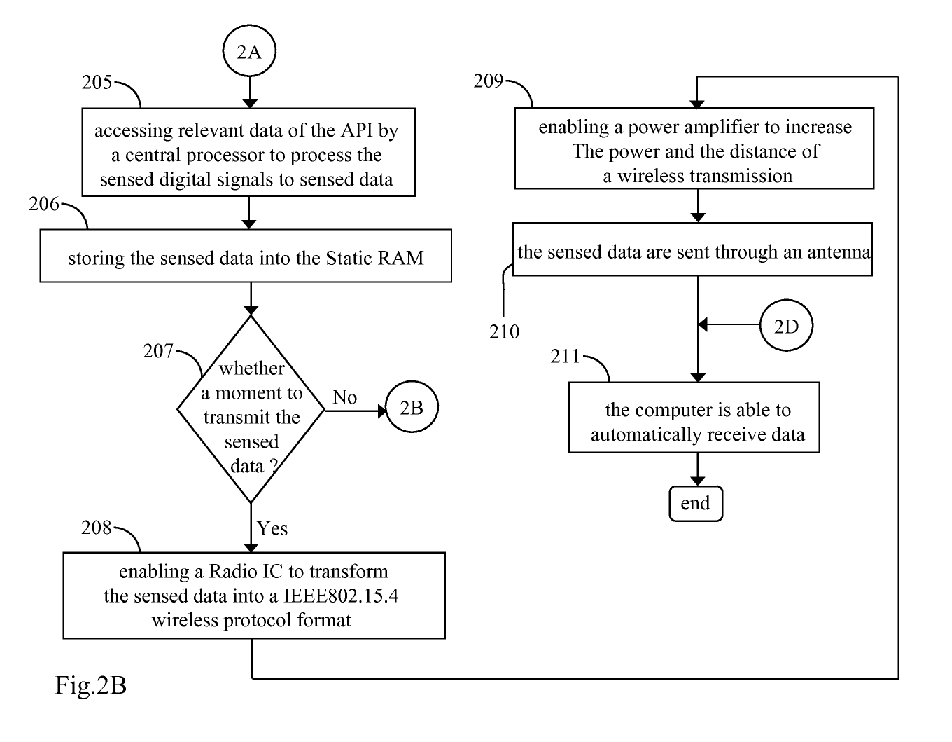

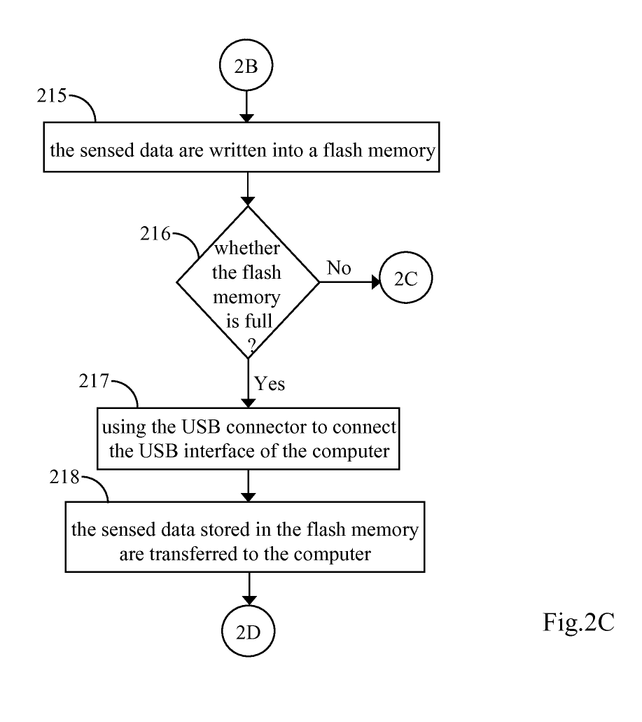

In addition to the aforementioned disclosure regarding various components and functions of the improved sensing module 100, FIG. 2A, FIG. 2B, and FIG. 2C are flow charts showing the steps of a sensing method for an improved sensing module 100. Initially in step 201, determining whether a sensed object is the same to previous one; if yes, going to step 202, that is, directly applying a sensor 110 to collect sensed signals, which are sensed analog signals. Then in step 203, the sensed analog signals are amplified by an amplifier 120; subsequently, in step 204, an Analog-to-Digital Converter (ADC) 136 transforms the sensed analog signal to sensed digital signals for a central processor core 132 to receive for further processing.

However, in aforementioned step 201, if the sensed object differs from the previous one, the end user have to update the data of an API first, i.e., the flow goes from step 212 to step 214, that is, enabling a USB connector 190 of the improved sensing module 100 to connect a USB interface of a computer, and then, storing the data of the API (such as sensor API, microprocessor-controlled API, or relevant API that is compiled by C language according to various sensed objects) into a Static RAM (SRAM)131 of a MCU 130; subsequently, the data of the API is written into an erasable programmable read only memory (EEPROM) 134 through the Static RAM (SRAM)131.

Beside, the aforementioned steps 212˜214 offer the end user to utilize an in-system programming device 143 of the MCU 130 to write required data of the API which are compiled according to various sensed objects into the EEPROM 134.

In step 205, the central processor 132 receives the sensed digital signals, continuously, the central processor 132 processes the sensed digital signals to produce sensed data by accessing the relevant API, thereafter, in Step 206, the central processor 132 stores the sensed data in the Static RAM (SRAM) 131. In step 207, determining whether a moment to send the sensed data is approached, that is set in Timer API by the user, if yes, the improved sensing module 100 automatically executes step 208 to enable a Radio IC 135 to transform the sensed data to a IEEE802.15.4 wireless protocol format, and then, to send out the sensed data through a wireless transmission, in addition, in step 209, to enable a power amplifier 150 to increase the power and the distance of the wireless transmission for the Radio IC 135, subsequently, in step 210, the sensed data are sent via an antenna 160; Finally, in step 211, the computer of the end user is able to automatically receive data through the wireless transmission. However, in the preferred embodiment, the Timer API of the improved sensing module 100 is set to send out the sensed data per three hours, so that the Radio IC 135 does not continuously send out data to consume the energy power of the battery 170 causing constant battery changes.

In addition, in step 207, if the moment for sending out the sensed data is not approached, the improved sensing module 100 automatically executes step 215, i.e., enabling the central processor 132 to activate a self programming device 143 to write the sensed data into a flash memory 133 through the Static RAM (SRAM) 131 for waiting until the moment to send the sensed data is approached, and then, the sensed data are sent through the wireless transmission. in step 216, that determines whether the flash memory 133 is full, if no, going back to step 202 to use the sensor 110 to continuously collect the sensed analog signals; however, if the flash memory 133 is full, the sensed data are manually captured from the flash memory 133, that is, in step 217˜step 218, using the USB connector 190 to connect the USB interface of the computer, so that the senses data stored in the flash memory 133 are capable of being transferred into the computer. Finally, in Step 211, after transferring the sensed data stored in flash memory 133 into the computer, the step flow is ended.

The improved sensing module 100 of the invention is able to automatically determine whether the sensed data are captured, and sent the sensed data out automatically through the wireless transmission or manually by the end user. Moreover, the sensor 110 comprises various sense components for sensing the following sensed objects: temperature, luminosity, humidity, oxygen, carbon monoxide, carbon dioxide, sulfur dioxide, ph value, or a combination of any two or more the above mentioned sensed objects. The aforementioned sensing module for detecting various sensed objects can be easily found in the market and are suitable to be placed in the sensor 110. Moreover, for increasing the accuracy of the sensed data, the invention applies the API for the MCU 130 to access for enabling calibration, correction, and controlling of various sensing components 1101. The API used in the improved sense module 100 contains sensor program API, MCU API, Timer API, UART API, SPI API, and C-language compiled API. Therefore, with the API, the present invention enables the connections for chips, such as the central processor 132, the Static RAM (SRAM) 131 and the Radio IC 135 via the I2C BUS 137. So that, various components of the improved sensing module 100 are able to communicate to one another to perform their functions, consequently, the improved sensing module 100 is capable of realizing wireless sensing accurately.

To compare with prior arts, the sensing method for the improved sensing module of the present invention has the following advantages:
1. The improved sensing module has various components with PCB layout design to provide wireless sensor platform for users.
2. The sensor contains more than one and above sensing components, therefore, the improved sensing module is capable of simultaneously sensing more than one and above sensed objects.
3. The MCU controls the moment to send out the sensed data on by accessing the Timer API, hence, the Radio IC does not continuously send out data to consume the energy power of the battery.
4. The improved sensing module comprises various module components with PCB layout design, such as the MCU, the amplifier, the power amplifier, etc., therefore, the improved sensing module can be fabricate to the size of pen drive with low cost.
5. The design of the invention is a double-sided PCB layout and grounded on bare copper to eliminate signal noise during executing wireless transmission, in addition, to improve the heat radiation of ICs heat radiation and stabilize the operation of ICs.
6. Various sensing components can be placed on the sensor for sensing required sensed objects, moreover, the MCU provides the user with the in-system programming device to update the relevant sensor API for rectifying the sensing components, and increasing the accuracy of wireless sensing.
7. The method of the present invention executes from collecting the sensed analog signals, processing the sensed analog signals, sending the sensed data, and enabling the computer of the end user to receive the sensed data, in which, the whole step flow is completed by the MCU with accessing the relevant API automatically through the wireless transmission without manpower required.

The above description is made on a best embodiment of the present invention. However, this embodiment is not intended to limit scope of the present invention, and all equivalent implementations or alterations within the spirit of the present invention still fall within the scope of the present invention.

What is claimed is:

1. A sensing method for an improved sensing module, comprising the steps of:
(1) determining whether a sensed object is the same to previous one; if so, going to step (2), otherwise, going to step (9);
(2) collecting sensed signals by using a sensor;
(3) processing the sensed signals to produce sensed data through a central processor;
(4) determining whether a moment to transmit the sensed data is approached; if so, going to step (5), otherwise, going to step (7);
(5) capturing and transmitting the sensed data;
(6) receiving the sensed data by a computer of an end user;
(7) writing the sensed data into a flash memory;
(8) determining whether the flash memory is full, if so, going to step (5), otherwise, going to step (2); and
(9) updating the data in an API (application programming interface) by the end user for executing step (2).

2. The sensing method for the improved sensing module according to claim 1, wherein step (2) further comprises the steps of:
(21) collecting sensed analog signals of the sensed object;
(22) amplifying the sensed analog signals by an amplifier; and
(23) transforming the amplified sensed analog signals into sensed digital signals by an Analog-to-Digital Converter (ADC).

3. The sensing method for the improved sensing module according to claim 1, wherein step (3) further comprises the steps of:
(31) accessing the API by the central processor to produce the sensed data; and
(32) storing the sensed data into a Static RAM (SRAM).

4. The sensing method for the improved sensing module according to claim 1, wherein step (9) further comprises the steps of:
(91) connecting a computer USB interface by a USB connector;
(92) storing the data in the API into the Static RAM (SRAM); and
(93) writing the data in the API into an erasable programmable read only memory (EPROM).

5. The sensing method according to claim 1, wherein the way of step (5) of capturing and transmitting the sensed data is selected from the group consisting of: manpower capturing and transmitting, and computer capturing and wireless transmitting.

6. The sensing method according to claim 1, wherein the sensed object is selected from the group consisting of: temperature, luminosity, humidity, oxygen, carbon monoxide, carbon dioxide, sulfur dioxide, ph value, and a combination of any two or more above mentioned.

7. The sensing method according to claim 1, wherein the API is selected from the group consisting of: a sensor API, an MCU API, a Timer API, a UART API, an SPI API, and a C-language compiled API.

8. An improved sensing module, comprising:
a sensor, comprising at least a sensing component to collect sensed analog signals of a sensed object;
an amplifier, amplifying the sensed analog signals;
an MCU (microprocessor control unit), comprising:
an Analog-to-Digital Converter (ADC), transforming the amplified sensed analog signals into sensed digital signals; and
a central processor, processing the sensed digital signals to sensed data.

9. The improved sensing module according to claim 8, further comprising:
a Radio IC, transforming the sensed data to a wireless protocol format and transmitting;
a power amplifier, increasing the power and the distance of a wireless transmission; and
an antenna, being as a media for sending and receiving data through the wireless transmission, so that the improved sensing module enables a computer to capture and transmit the sensed data by way of the wireless transmission.

10. The improved sensing module according to claim 9, further comprising:
a battery, providing electric power to operate the improved sensing module; and
a connector, connecting an external IC.

11. The improved sensing module according to claim 8, wherein the MCU further comprising:
a Static RAM (SRAM), which is a temporary data storage area for temporarily storing the sensed data after being processed by the central processor;
a flash memory, being as a storage area for the sensed data;
an EEPROM, being as a storage area for the data in an API (application programming interface) required by the improved sensing module;
an I2C BUS as the connections for the central processor to the outside of the central processor;
an I/O interface as an input and output interface for the MCU;
a universal asynchronous receiver transmitter (UART), which is a transmission device for transmitting serial data among the MCU and peripheral devices;
a serial peripheral interface (SPI), which transmits serial data among the MCU and the peripheral devices;
a DC/DC Converter, increasing or reducing the electric power voltage of the battery;
an in-system programming device, providing a user with the in-system programming function through the serial peripheral interface (SPI) to update the API; and
a self programming device, providing the function of writing the sensed data into the flash memory.

12. The improved sensing module according to claim 8 further comprising a USB connector to directly connect a USB interface of a computer, in order to capture and transmit the sensed data by manpower.

13. The improved sensing module according to claim 12, further comprising:
a battery, providing electric power to operater the improved sensing module; and
a connector, connecting an external IC.

14. The improved sensing module according to claim 12, wherein the MCU further comprises:
a Static RAM (SRAM), which is a temporary data storage area for storing the sensed data after being processed by the central processor;
a flash memory as a storage area for the sensed data;
an EEPROM as a storage area for the data in the API required by the improved sensing module;
an I2C BUS as the connections between the central processor, and the Static RAM (SRAM);
an I/O interface between the MCU and an external IC;
a universal asynchronous receiver transmitter (UART), which transmits serial data between the MCU and peripheral devices;
a serial peripheral interface (SPI), which transmits the serial data between the MCU and the peripheral devices;
a DC/DC Converter, increasing or reducing the electric power voltage of the battery;
an in-system programming device, providing a user with the in-system programming function through the serial peripheral interface (SPI) to update the API; and
a self programming device providing the function of writing the sensed data into the flash memory.
